(19) United States
(12) Patent Application Publication
(10) Pub. No.: US 2006/0031852 A1
(43) Pub. Date: Feb. 9, 2006

(54) Virtualization of control software for communication devices

(76) Inventors: Wenjing Chu, Sunnyvale, CA (US); James (Qiuming) Li, Sunnyvale, CA (US); Ravi Manghimalani, Fremont, CA (US); Bisong Tao, San Jose, CA (US); Susan Hares, Saline, MI (US)

Correspondence Address: PERKINS COIE LLP, P.O. BOX 2168, MENLO PARK, CA, 94026, US

(21) Appl. No.: 11/121,162

(22) Filed: May 2, 2005

Related U.S. Application Data
(60) Provisional application No. 60/567,358, filed on Apr. 30, 2004.

(51) Int. Cl. G06F 9/44; G06F 15/173

(52) U.S. Cl. 719/320; 709/223

(57) ABSTRACT

A method and system for virtualization of control software for a communication device is disclosed. A virtual communication environment is provided to support the virtualization of communication devices. Such a virtual communication environment creates, links and manages virtual communication processes that are associated with the virtual communication devices.

### CROSS REFERENCE TO RELATED APPLICATIONS

This application claims the benefit of U.S. Provisional Patent Application No. 60/567,358 filed Apr. 30, 2004, entitled, “VIRTUALIZATION OF CONTROL SOFTWARE FOR COMMUNICATION DEVICES,” by Hares et al., and which is hereby incorporated by reference in its entirety.

This application further incorporates by reference in their entirety each of the following U.S. patent applications:

U.S. patent application No. U.S. patent application Ser. No. 10/648,141, filed on Aug. 25, 2003 (Atty. Docket No.: 41434-8001.US00).

U.S. patent application Ser. No. 10/648,146, filed on Aug. 25, 2003 (Atty. Docket No.: 41434-8002.US00).

U.S. patent application Ser. No. 10/648,758; filed on Aug. 25, 2003 (Atty. Docket No.: 41434-8003.US00).

U.S. patent application Ser. No. 60/567,192 filed Apr. 30, 2004, entitled, “REMOTE MANAGEMENT OF COMMUNICATION DEVICES,” by Hares et al. (Atty. Docket No.: 41434-8010.US00).

U.S. patent application Ser. No. ______ filed May 2, 2005, entitled, “REMOTE MANAGEMENT OF Communication DEVICES,” by Susan Hares et al. (Atty. Docket No.: 41434-8010.US01).

### TECHNICAL FIELD

The present invention IS field of communications, and more specifically, to a virtual communication environment.

### BACKGROUND

The proliferation of hardware devices in computer networks has resulted in the virtualization of network devices such as firewalls, route-servers, network-access devices and network-management devices. However, the virtualization of network devices has its own set of problems. Several inefficiencies occur across communication processes within a node. Further, several inefficiencies are present in the connectivity of between virtual communication systems, such as inefficiencies in the virtualization interface and routing process across systems. Further, the management of large numbers of virtual communication devices such as virtual routers with several interfaces pose a significant challenge.

In view of the foregoing, there is a need for a system and method for scaling and managing virtual communication SYSTEMS.

### SUMMARY

Embodiments of the invention support the virtualization of control software for communication devices by providing a virtual engine framework, and a canonical interface (APIs) for a virtual communication environment. According to certain embodiments, a virtual communication environment runs communication processes collaboratively to support the virtualization of communication devices such as, by way of non-limiting example, firewalls, routers, switches, mobile environments, security gateways, storage area networks, or network access equipment.

The virtual communication environment allows for the creation, linking and management of virtual communication processes in order to create virtual communications devices that can span several modules within a process, across multiple processes in a machine, or across multiple processes in multiple machines. The virtual communication processes may exchange information via a variety of communication protocols. The virtual communication environment is sufficiently flexible to be collapsed to a single monolithic communication process or alternatively enhanced to suit the requirements of communicating entities across multiple target platforms. These and other embodiments of the invention are described in further detail herein.

### BRIEF DESCRIPTION OF THE DRAWINGS

FIG. 1 ILLUSTRATES the vrEngine framework, according to certain embodiments.

FIG. 2 ILLUSTRATES a vrEngine instance that spans multiple nodes, according to certain embodiments.

FIG. 3 ILLUSTRATES a vrEngine instance for implementing Simple Network Management Protocol AGENT relays, according to certain embodiments.

FIG. 4A illustrates a logical representation of the BR architecture, according to certain EMBODIMENTS.

FIG. 4B ILLUSTRATES a vrEngine instance for implementing a BR that supports a 2547 policy, according to certain embodiments.

FIG. 5 ILLUSTRATES a vrEngine instance for implementing a virtual interface manager application, according to certain embodiments.

FIG. 6 illustrates a vrEngine instance for implementing a secure key management application, according to certain embodiments.

FIG. 7 illustrates the relationship between vrMgr and vrClients, according to certain embodiments.

FIG. 8 illustrates the format of the Resolve, and Resolve-Reply messages, according to certain embodiments.

FIG. 9 ILLUSTRATES the format of the Register and Deregister messages, according to certain embodiments.

FIG. 10 ILLUSTRATES the format of the Send, I-am-server, Kill-client messages, according to certain embodiments.

FIG. 11A illustrates the tasks associated with a vrMgr API, according to certain embodiments.

FIG. 11B illustrates the tasks associated with a vrClient API, according to certain embodiments.

### DETAILED DESCRIPTION

According to certain embodiments, a virtualization of control software for communication devices is enabled by providing a virtual engine framework (“vrEngine framework”), and a canonical interface (APIs) for a virtual communication environment. According to certain embodiments, a virtual communication environment is an environment in which communication processes run in collaboration to support the virtualization of communication devices such as firewalls, routers, switches, mobile environments, security gateways, or network access equipment, for example.

The virtual communication environment allows for the creation, linking and management of virtual communication processes in order to create virtual communications devices that can span several modules within a process, across multiple processes in a machine, or across multiple processes in multiple machines. The virtual communication processes exchange information via a variety of communication protocols that can include but are not limited to TCP and Inter-Process Communication (IPC).

Such a virtual communication environment is general enough to be collapsed to a single monolithic communication process or it can be enhanced to suit the requirements of communicating entities across multiple target platforms.

The vrEngine framework for the virtual communication includes the following concepts:
vrEngine: vrEngine is a single instance of virtual communication environment.
vEngine module: a vEngine module is a module running the vEngine base code for some applications. The vEngine modules has application tasks (vTasks) that communicate with other application tasks.
vTasks: vTasks is an application module operating as a functional module within the vEngine module.
vrClient: vrClient is an instance of the vEngine module that is an virtual communication end point. Software tasks and protocols run on a vrClient.
vrMgr: vrMgr is an instance of vEngine module that manages the existence, naming and communications between a group of vrClients. The vrMgr becomes a clearinghouse for the status of vrClients and vTasks within vrClients that need to communicate with vTasks on other vrClients.
Client vrMgr: Client vrMgr is a vrClient that becomes a vrMgr for other vrClients to provide multiplexing services under the guidance of the original vrMgr.
vrApplication: A vrApplication is an application that runs on a vEngine module in support of communication devices.
vrMgrApplication: A vrMgrApplication is a vrApplication that runs on a vrMgr in support of communication devices.
vrIPC: vrIPC is a protocol for passing information between vEngine modules.
vrIPC module: The vrIPC module is the vEngine software module that handles encoding and decoding the vrIPC protocol.
vrIPC API: The vrIPC API is a canonical advanced programming interface (API) that allows vrApplications running on a vEngine (vrClient, vrMgr or Client vrMgr) to interface to the vrIPC module for using the vrIPC protocol.
vrMgrApp API: The vrMgrApp API is a canonical advanced programming interface (API) that allows vrMgrApplications to interface to the vrMgr functions.

A virtual communication device running for a particular application creates an instance of the vrEngine Framework. At the heart of each virtual communication device is an application. Virtual communication devices utilize virtual applications that are herein referred to as vrApplications. The vrApplication runs in a virtual process and controls vrMgr via the vrMgrApp API. The vrApplication and associated configuration support determine what applications modules (vTasks) go in vrClients or Client vrMgrs. The vrApplication determines what vTasks need to communicate with other vTasks in other vrClients. The application coordinates the whole group of software processes to act as a set of virtual communications devices. A virtual communication device can operate on one device or across many physical devices. A vrMgrApplication utilizes the vrMgr to create and/or destroy vrClient or client vrMgr with the correct application tasks at the appropriate time for the application. The vrMgrApplication uses the vrMgr's vrMgrApp API to add, delete, modify vrClients serving as communication end-point clients (vrClient) or a next level application manager (Client VrMgr) of groups of vrClients. The vrMgr establishes a communication link between vrClients (end-point or Client vrMgr), and allows information to flow between application tasks on different clients.

Remote messaging processes encodes the information into messages and passes the messages between a remote management process and the router/communication process. The remote process can communicate with the routing process via any communication method that can exchange messages.

Examples of applications that can are run in a virtual communication environment include but are not limited to:
1) an MPLS Border Router (MPLS Layer 3 VPN PE/CE combination) that can support 500 CE per PE,
2) a virtual firewall that supports 500 virtual routing engines associated with virtual connections, and
3) ethernet switches that support 100 s of virtual LAN connections for Virtual LAN Services (via VPLS).

A vrEngine environment may have vEngine modules for vrClients, Client VrMgrs and a vrMgr running an application. Each vEngine module may have vTasks that perform some communication function. An example of a vTask for a router application vEngine is the OSPF protocol. There are no limits to the physical instantiation of the virtual engines. There are no constraints on the interaction network management processes for configuration or remote monitoring of fault, performance or accounting (security) functions.

The vrClient can be a virtual communication end-point or provide multiplexing services for a group of vrClients. Multiplexing services include but are not limited to: 1) relay services for configuration information, network management, or network protocol, 2) processing of devices or information common to all vrClients, or 3) delegation of services. A vrClient performing multiplexing services becomes a Client vrMgr.

The vrIPC protocol has messages to 1) register/de-register vrClients, 2) register/deregister tasks on clients, 3) resolve where a task is in the vrEngine environment (resolve/resolve-reply), and 4) send messages to vrMgr/vrClient, 5) allow a vrMgr or ClientvrMgr declare itself as a relay point, and 6) instruct the vrMgr to kill a client.

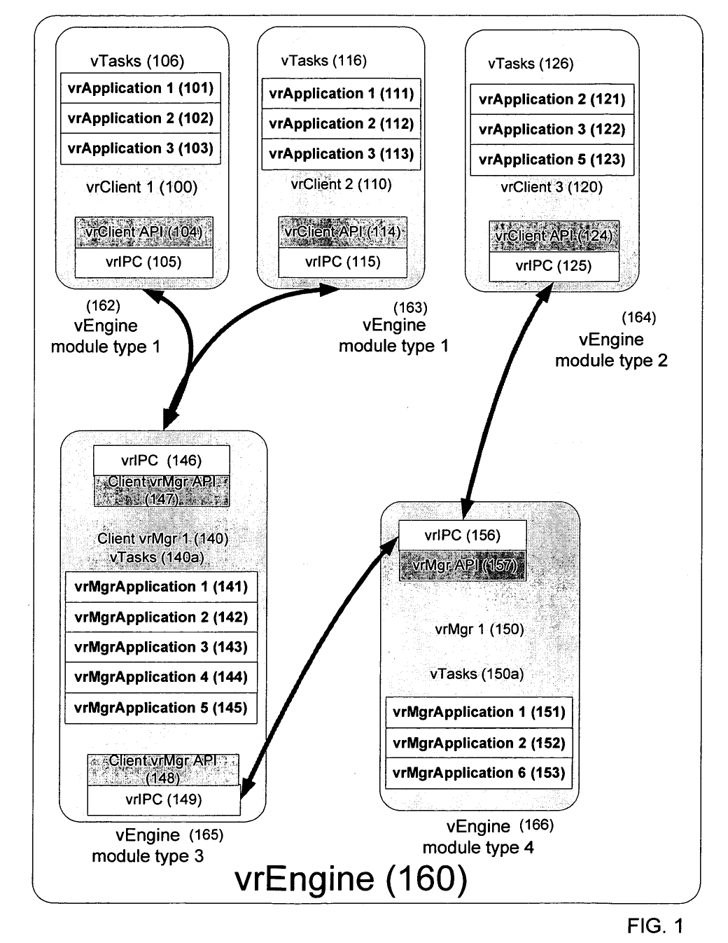

FIG. 1 Illustrates the vrEngine framework, according to certain embodiments. FIG. 1 shows a virtual communication environment vrEngine instance 160. Virtual communication environment vrEngine instance 160 includes a plurality of vEngine modules 162, 163, 164, 165, and 166. For purposes of explanation, vEngine modules 162, 163, and 164 are implemented as vrClients 100, 110 and 120, respectively. vEngine modules 165, and 166 are implemented as Client vrMgr 140 and a vrMgr 150, respectively. The number and type of vEngine modules may vary from implementation to implementation.

vrMgr 150 includes a vrIPC 156, vrMgr API 157 and vTasks 150a that comprises vrMgrApplications 151, 152 and 153. Client vrMgr 140 includes a vrIPC 146, Client vrMgr API 147 and vTasks 140a that comprises vrMgrApplications 141, 142, 143, 144, and 145.

vrClient 100 includes a vrIPC 105, vrClient API 104 and vTasks 106 that comprises vrApplications 101, 102 and 103. Similarly, vrClient 110 includes a vrIPC 115, vrClient API 114 and vTasks 116 that comprises vrApplications 111, 112 and 113. vrClient 120 includes a vrIPC 125, vrClient API 124 and vTasks 126 that comprises vrApplications 121, 122 and 123.

FIG. 1 also shows that communication between the vEngine modules is through the respective APIs such as Client vrMgr API 147, vrMgr API 157 and vrClient APIs 104, 112, and 124 using communication protocols vrIPC 105, 115, 125, 149, and 156, for example. The vrMgr 150 can create new vrClients and Client vrMgrs or destroy existing vrClients and Client vrMgrs. The vrMgr 150 also creates the application tasks for vrClients and Client vrMgrs. Client vrMgr 140 is a vrClient that provides multiplexing services under the guidance of the or vrMgr 150.

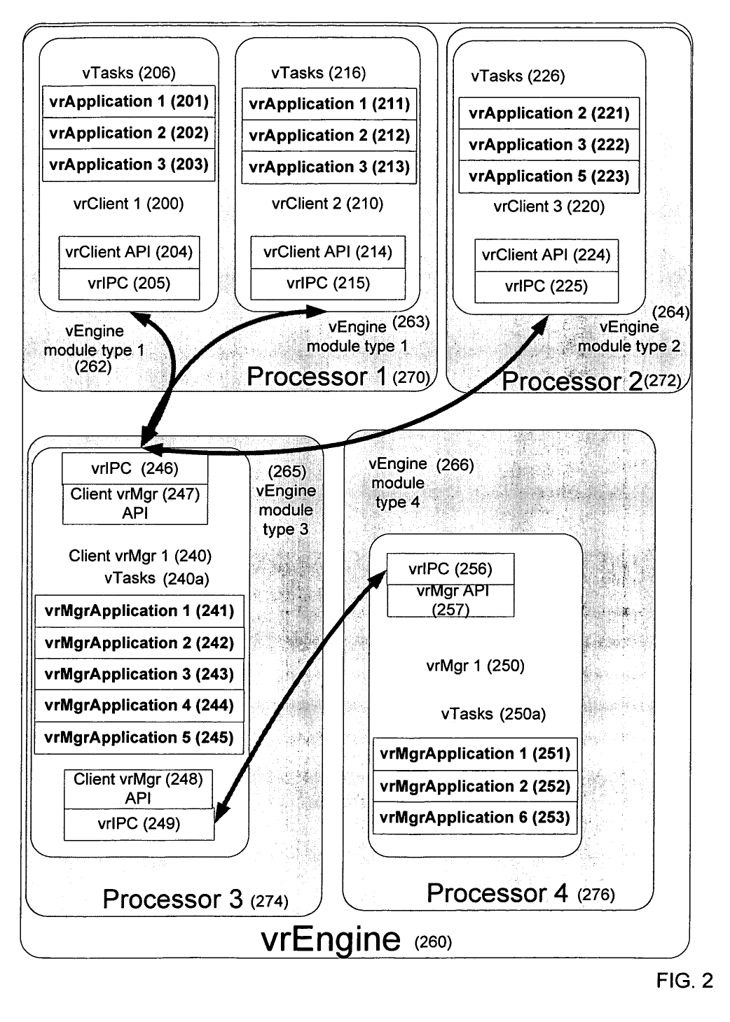

FIG. 2 illustrates a vrEngine instance that spans multiple nodes, according to certain embodiments. In FIG. 2, the communication processes occur across multiples processors or nodes such as nodes 270, 272, 274, and 276. FIG. 2 shows a virtual communication environment vrEngine instance 260. Virtual communication environment vrEngine instance 260 includes a plurality of vEngine modules 262, 263, 264, 265, and 266. For purposes of explanation, vEngine modules 262, 263, and 264 are implemented as vrClients 200, 210 and 220, respectively. vEngine modules 265, and 266 are implemented as Client vrMgr 240 and a vrMgr 250, respectively. vrMgr 250 includes a vrIPC 256, vrMgr API 257 and vTasks 250a that comprises vrMgrApplications 251, 252 and 253. Client vrMgr 240 includes a vrIPC 246, Client vrMgrAPI 247 and vTasks 240a that comprises vrMgrApplications 241, 242, 243, 244, and 245.

vrClient 200 includes a vrIPC 205, vrClient API 204 and vTasks 206 that comprises vrApplications 201, 202 and 203. Similarly, vrClient 210 includes a vrIPC 215, vrClient API 214 and vTasks 216 that comprises vrApplications 211, 212 and 213. vrClient 220 includes a vrIPC 225, vrClient API 224 and vTasks 226 that comprises vrApplications 221, 222 and 223.

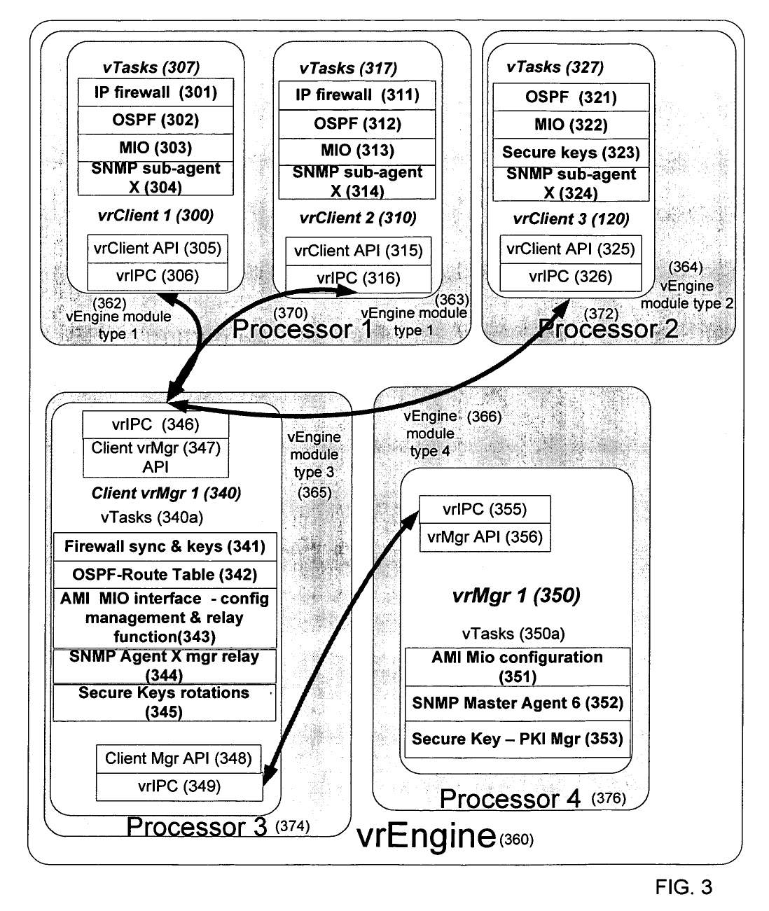

FIG. 3 illustrates a vrEngine instance for implementing Simple Network Management Protocol agent relays, according to certain embodiments. FIG. 3 shows a virtual communication environment vrEngine instance 360 that includes a plurality of vEngine modules 362, 363, 364, 365, and 366. vEngine modules 362, 363, and 364 are implemented as vrClients 300, 310 and 320, respectively. vEngine modules 365, and 366 are implemented as Client vrMgr 340 and a vrMgr 350, respectively. vEngine modules 362, 363 are implemented on node 370. vEngine module 364 is on node 372. Client vrMgr 340 and a vrMgr 350 are implemented on nodes 374 and 376, respectively.

vrMgr 350 includes a vrIPC 355, vrMgr API 356 and vTasks 350a that comprises an AMI MIO configuration 351, an SNMP master agent 352, and a secure key PKI manager 353. Client vrMgr 340 includes vrIPC 346, 349 and Client vrMgr APIs 347, 348 and vTasks 340a that comprises firewall synchronization and keys 341, an OSPF route table 342, an AMI MIO interface configuration management and relay function 343, an SNMP agent manager relay 344, and secure key rotations 345.

vrClient 300 includes a vrIPC 306, vrClient API 305 and vTasks 307 that comprises an IP firewall 301, an OSPF 302, an MIO 303 and an SNMP sub-agent 304. Similarly, vrClient 310 includes a vrIPC 316, vrClient API 315 and vTasks 317 that comprises an IP firewall 311, an OSPF 312, an MIO 313 and an SNMP sub-agent 314. vrClient 320 includes a vrIPC 326, vrClient API 325 and vTasks 327 that comprises an OSPF 321, an MIO 322, secure keys 323 and an SNMP sub-agent 324. Communication between vrMgr, Client vrMgr and vrClients are through their respective APIs and vrIPC protocols.

Non-limiting, illustrative examples of vrMgrApplications that utilize the vrMgr include but are not limited to the backbone router (BR) that supports an MPLS 2547 policy and the Virtual Master Agent for sub-agents within Virtual instances.

BR Application on vrMgr

The BR application is one embodiment of the vrEngine environment. The communicating entities in the BR are tasks in different routing processes running on the same target platform. The BR vrEngine environment includes a vrMgr (a new routing task providing the communication infrastructure), a vrClient (a new routing task in each communicating routing process) along with the vrClient API for use by tasks within the routing process and the communication protocol between the vrMgr and the vrClients. Only one instance of vrMgr is needed and is embedded in a specially marked routing process “BR” (backbone router) used for provide backbone router services. Also, the protocol between the vrMgr and the vrClient within the “BR” is greatly simplified and is mapped to the inter-task communication facility (gMsg) as both the vrMgr and the vrClient of the “BR” are encased within the same process.

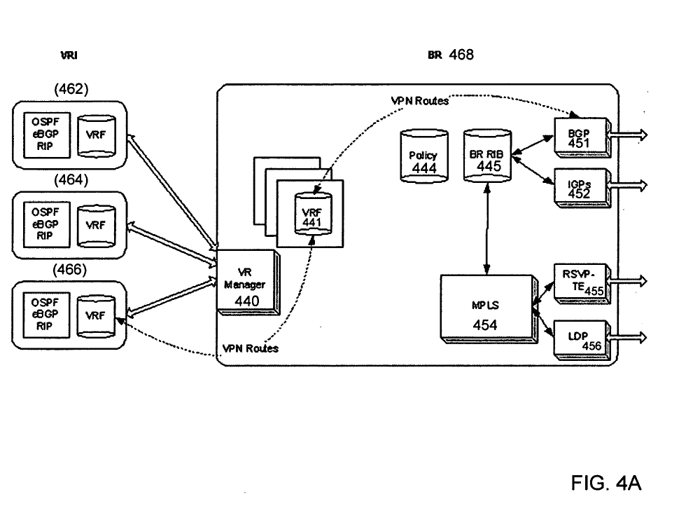

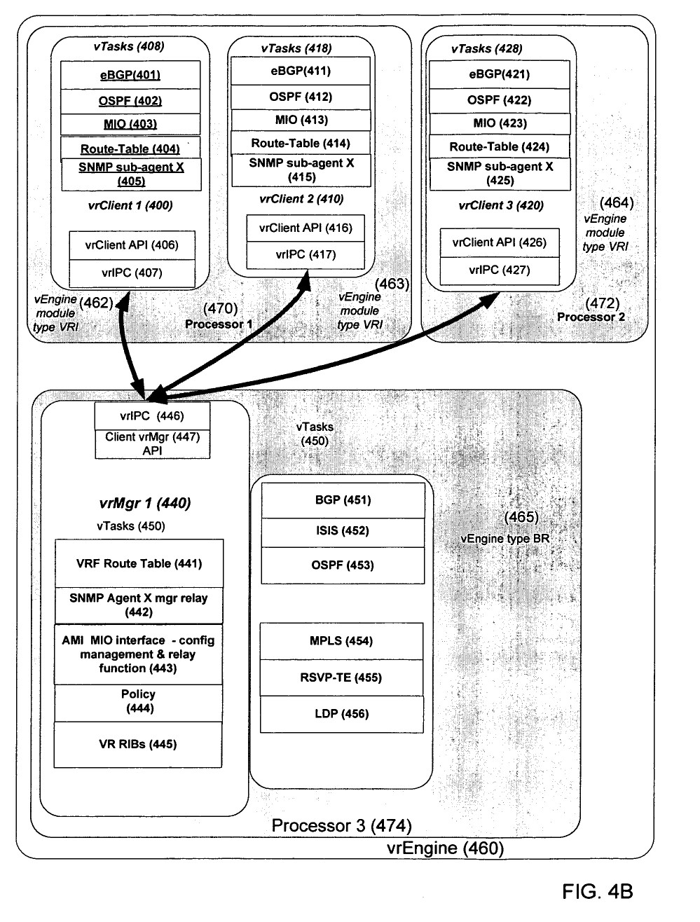

FIG. 4A illustrates a logical representation of the BR architecture, according to certain embodiments. FIG. 4A shows a BR 468 and virtual router instances (VRI) 462, 464, and 466. BR 468 includes a virtual router manager 440, a VPN routing/forwarding instance 441, policy 444, BR routing information base (RIB) 445, border gateway protocol (BGP) 451, interior gateway protocol 452, multi-protocol label switching 454, resource reservation protocol (RSVP) 455 and label distribution protocol (LDP) 456.

FIG. 4B illustrates a vrEngine instance for implementing a BR that supports a 2547 policy, according to certain embodiments. The 2547 policy is a policy whereby a IP backbone may provide VPNs using MPLS for forwarding packets over the backbone and using BGP for distributing routes over the backbone. FIG. 4B shows a virtual communication environment vrEngine instance 460 that includes a plurality of vEngine modules 462, 463, 464, and 465. vEngine modules 462, 463, and 464 are implemented as vrClients 400, 410 and 420, respectively. vEngine module 465 is implemented as a BR using a vrMgr 440. vEngine modules 462, 463 are implemented on node 470. vEngine module 464 is implemented on node 472 and vrMgr 440 is implemented on node 474.

vrMgr 440 includes a vrIPC 446, vrMgr API 447 and vTasks 450 that comprises a VRF route table 441, an SNMP agent manager relay 442, an AMI MIO interface configuration management and relay function 443, policy 444, VR RIBs 445, BGP 451, ISIS 452, OSPF 453, MPLS 454, RSVP-TE 455 and LDP 456.

vrClient 400 includes a vrIPC 407, vrClient API 406 and vTasks 408 that comprises an eBGP 401, an OSPF 402, an MIO 403, route table 404 and an SNMP sub-agent 405. Similarly, vrClient 410 includes a vrIPC 417, vrClient API 416 and vTasks 418 that comprises an eBGP 411, an OSPF 412, an MIO 413, route table 414 and an SNMP sub-agent 415. vrClient 420 includes a vrIPC 427, vrClient API 426 and vTasks 428 that comprises an eBGP 421, an OSPF 422, an MIO 423, route table 424 and an SNMP sub-agent 425.

The BR vrEngine includes the following concepts:
1. Virtual Routing Engine (vr_engine):
A VR engine is an instance of routing software that implements a virtual routing environment.
2. Virtual Router (VR):
A Virtual Router is an instance of VPN routing (such as a VRF). VR can have many different flavors. An example of VRF as defined in RFC2547.
At least one VR instance is inside one of the VR engines.
3. Main Backbone Router (BR):
BR takes the normal configuration statements and is a normal instance of routing software (a non-limiting example of which is GateD; other suitable examples shall be readily apparent to those skilled in the art). Interfaces that are not associated with any VR are part of the BR by default. BR is not necessarily a network “backbone”.
For BGP/MPLS VPN, BR runs iBGP for the PE router and MPLS. BR includes the Internet (global) routing table as well.
Another important component is vrMgr. vrMgr manages vrEngines.
   Configuration of Software Modules

An external configuration manager (such as that of a customer) speaks to the BR via MIO API. Configuration information that is relevant to virtual routes are relayed by the vrMgr to the proper instance's own MIO module.

Relay Configuration

“Axiom”—the configuration manager communicates with a single routing process (referred to as BR in this document) to achieve the correct operational semantics for the virtual routing environments.

Add Operation (Creation of New vr_Engines)

While getting MIO messages or calls when BR encounters vr_engine statements, vr routing processes are spawned via the (task_)vfork/execle standard C library calls. The path and file names and the environment variables of the newly spawned vr routing process are those inherited by BR when it is invoked via the shell. It is assumed that before any vr routing processes are spawned, the vrMgr listener task is appropriately setup. The vrMgr listener task is used in the inter-process communication between the BR and the vr routing processes. The process is identical if configured via a XML based configuration manager. Initial setting is passed for the new vr routing processes spawned using the execle function call (protocol family, port number, to use to contact the BR) via command arguments (char *argv□) to establish the vr routing mode. It is the responsibility of the BR to feed the configuration information to the newly spawned vr routing process. Configuration information is fed via the inter-process communication mechanism (not the MIO port). The configuration information will be fed to the configuration agent in binary TLV via the inter-task communication method. The global configuration and the vr routing specific (vr_engine scoped) are provided to the target vr routing process. It is assumed that binary coded TLV can be generated from the parsed MIO structures. In the mioSet( ) handler corresponding to the vr_engine, the configuration processing is undertaken for the vr process. A MIO structure walk is undertaken to supply the global setting and traversal within the context of the vr_engine to supply the specific information pertaining to the vr engine. A general macro can be used to maintain a single binary of the routing software (VR_ENABLED( ), VR_MASTER( ) to refer to BR specifics, and VR_SLAVE( ) to refer to vr specifics). The default behavior is to execute like BR with the BR passing command line arguments to identical images to act like vr routing processes. This implies that the configuration agent is able to accept binary encoded TLV messages directly over its well-known AF_STREAM (TCP port) or via the vr-manager intercommunication protocol. The BR routing process uses the former method while the vr engine process utilizes the latter.

Delete Operation (Deletion of Existing vr_Engines)

On receiving XML messages to delete/disable an existing vr_engine in the mioDelete( ) handler, notifications are sent to the vr routing processes to commit suicide (or notify the vr engine to orderly undertake a shutdown). As a result of the orderly shutdown of the vr_engine (vr processes), the exported routes or other dynamically created structures in BR are freed and the inter-process communication socket or channel is closed. Finally, a call to the _exit standard C library call is made.

Modify Operations (Changes Made to an Existing vr_Engine)

The modify operation can be classified as two distinct operations: 1) modifications to the global configuration tree, and 2) modifications within the vr_engine scope sub-tree. Modifications to the global configuration tree are relayed to all (broadcasted) currently running vr routing process (vr_engines). The master BR routing has a list of all vr_engines and a mapping of the process ids for use by the inter-process communication subsection. A modification within the scope of a vr_engine sub-tree translates to a relay of the binary TLV oriented messages to the appropriate vr_engine. Helper routines in MIO determine whether the add/modify/delete operation refers to the global context or within the scope of a vr_engine. Implementation includes providing a generic function in the MIO internals which analyses the configuration binary TLV to determine whether vr enabled/disabled and if enabled, then determine if operation is in server (BR) mode or vr mode. If operating in the server (BR) mode, the configuration is analyzed to decipher whether the configuration is within the global or is contained within the vr_engine sub-tree scope. Global scope changes are broadcasted to every vr_engine (routing process) via the inter-process communication facility while the appropriate vr_engine receives the personal vr_engine sub-tree scoped messages.

MIO Based Configuration of VR Engines

There are two methods of configuring vr engines via MIO. The first method relies on configuring each vr engine independently via MIO. The second method relies on configuring each vr instance by relaying the MIO messages through the vrMgr server “BR” instance. When MIO relaying feature is used, the MIO commands meant from the vr engine can be steered via the vrMgr server. A new client vri_agt of vrMgr aids in MIO relaying by sending the commands and recovering the responses. The vri_agt parcels the MIO commands and sends the commands via the vrMgr communication channel to the appropriate mioagt. The responses are parceled back in the reverse direction. The user exit functions for this purpose ia vri_agt.c::agt_engine_recv for processing the reply from the Client vrMgr.

Delegated Client vrMgr Application

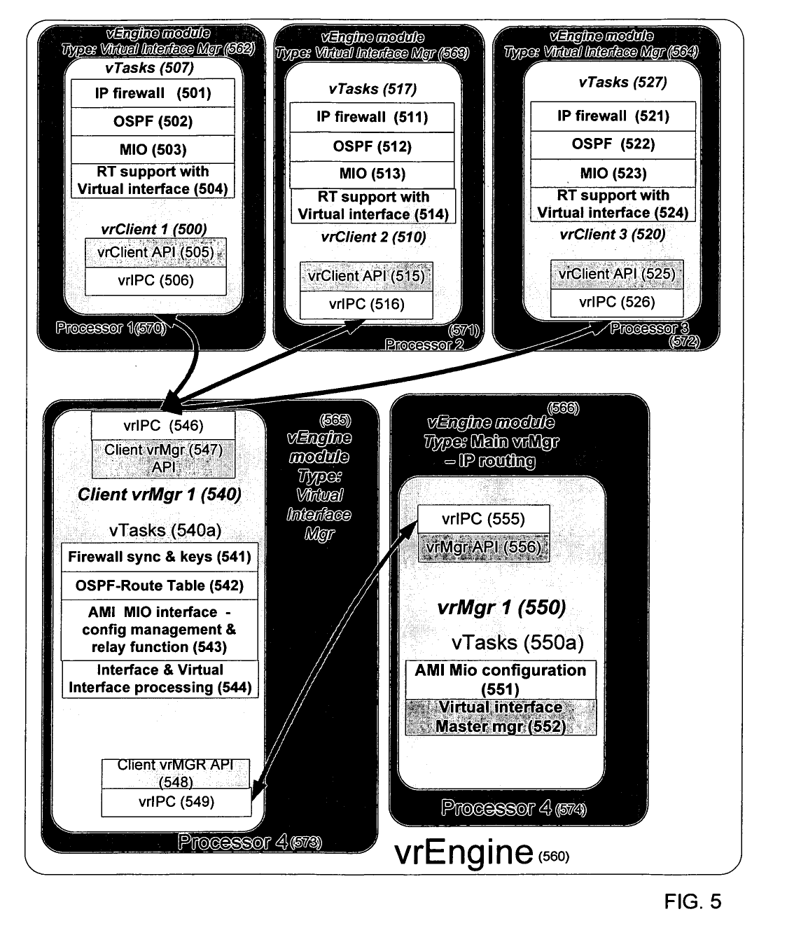

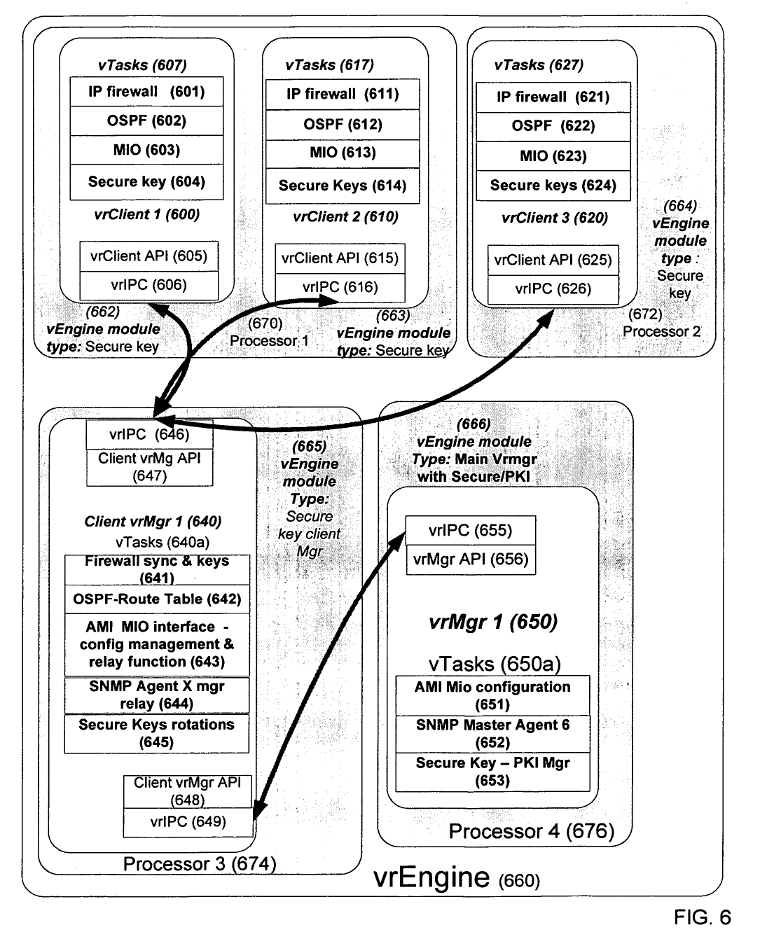

Examples of a delegated Client vrMgr application include but are not limited to 1) a Virtual Interface Manager application (see FIG. 5) to centralize the handling of interfaces to single client vrMgr and 2) Secure key management rotation (see FIG. 6) for BGP peers to a single client vrMgr.

FIG. 5 illustrates a vrEngine instance for implementing a virtual interface manager application, according to certain embodiments. FIG. 5 shows a virtual communication environment vrEngine instance 560 that includes a plurality of vEngine modules 562, 563, 564, 565, and 566 that function as virtual interface managers. vEngine modules 562, 563, and 564 are implemented as vrClients 500, 510 and 520, respectively. vEngine modules 565, and 566 are implemented as Client vrMgr 540 and a vrMgr 550, respectively. vEngine modules 562, 563, 564 are implemented on nodes 570, 571 and 572, respectively. vEngine modules 565, 566 are implemented on nodes 573 and 574, respectively.

vrMgr 550 includes a vrIPC 555, vrMgr API 356 and vTasks 550a that comprises an AMI MIO configuration 551, and a virtual interface master manager 552. Client vrMgr 540 includes vrIPC 546, 549 and Client vrMgr APIs 547, 548 and vTasks 540a that comprises firewall synchronization and keys 541, an OSPF route table 542, an AMI MIO interface configuration management and relay function 543, and Interface and virtual interface processing 544.

vrClient 500 includes a vrIPC 506, vrClient API 505 and vTasks 507 that comprises an IP firewall 501, an OSPF 502, an MIO 503 and an RT support with virtual interface 504. Similarly, vrClient 510 includes a vrIPC 516, vrClient API 515 and vTasks 517 that comprises an IP firewall 511, an OSPF 512, an MIO 513 and an RT support with virtual interface 514. vrClient 520 includes a vrIPC 526, vrClient API 525 and vTasks 527 that comprises a IP firewall 521, an OSPF 522, an MIO 523, and an RT support with virtual interface 524. Communication between vrMgr, Client vrMgr and vrClients are through their respective APIs and vrIPC protocols.

FIG. 6 illustrates a vrEngine instance for implementing a secure key management application, according to certain embodiments. FIG. 6 shows a virtual communication environment vrEngine instance 660 that includes vEngine modules 662, 663, and 664 that are implemented as vrClients 600, 610 and 620, respectively. FIG. 6 alos shows vEngine modules 665, and 666 that are implemented as Client vrMgr 640 and a vrMgr 650, respectively. vEngine modules 662, 663 are implemented on node 670. vEngine module 664 is on node 672. Client vrMgr 640 and a vrMgr 650 are implemented on nodes 674 and 676, respectively.

vrMgr 650 includes a vrIPC 655, vrMgr API 656 and vTasks 650a that comprises an AMI MIO configuration 651, an SNMP master agent 652, and a secure key PKI manager 653. Client vrMgr 640 includes vrIPC 646, 649 and Client vrMgr APIs 647, 648 and vTasks 640a that comprises firewall synchronization and keys 641, an OSPF route table 642, an AMI MIO interface configuration management and relay function 643, an SNMP agent manager relay 644, and secure key rotations 645.

vrClient 600 includes a vrIPC 606, vrClient API 605 and vTasks 607 that comprises an IP firewall 601, an OSPF 602, an MIO 603 and secure keys 604. Similarly, vrClient 610 includes a vrIPC 616, vrClient API 615 and vTasks 617 that comprises an IP firewall 611, an OSPF 612, an MIO 613 and secure keys 614. vrClient 320 includes a vrIPC 326, vrClient API 325 and vTasks 327 that comprises an IP firewall 621, OSPF 622, an MIO 623 and secure keys 624. Communication between vrMgr, Client vrMgr and vrClients are through their respective APIs and vrIPC protocols.

VrApplications Running Without a vrMgr

A vrApplication can start vrClients without the management support of a vrMgr. Exterior services remotely configure and monitor in real-time the vrClients. vrClients may utilize a reduced set of the vrMgr API (just listen and modify, for example).

vrMgr And vrClient Normal Operations

The vrMgr coordinates name resolution service for associated vrClients and vTasks. The vrMgr takes an active roll in detecting the comings and goings of vrClients. If the vrMgr fails to detect the presence of a vrClient, the vrMgr reports the absence of the vrClient to the application and other associated vrClients.

vrMgr opens a well known listener for connecting requests from vrClients. The sequenced delivery mechanism of messages in the underlying communication protocol is exploited to assure that the connection requests from vrClients (end-point or Client vrMgr) are heard.

If the vrMgr spawns a vrClient, the spawning occurs under the control of a vrApplication. After spawning, the vrMgr opens a connection to the vrClient over a communication protocol. Upon opening a connection to the vrMgr, the vrClient sends a REGISTER messages via the vrIPC protocol. The vrMgr tracks the new existence of vrClients by the REGISTER message. Upon receiving the REGISTER message, the vrMgr stores the information about the connection.

The vrClient, upon bringing up an application task that requires communication with other tasks, will use the REGISTER_TASK message to indicate to the vrMgr that a given task is requesting communication to with another task. The vrMgr, upon receiving the REGISTER_TASK message, will check the “pending resolve” list to determine if any vTask(s) from any vrClient has been waiting for this vTask by name. If so, the vrMgr sends the RESOLVE_RESPONSE message corresponding to each task to the appropriate vrClient. Upon receiving the RESOLVE_RESPONSE message, the vrClient will allow messages to be sent via the SEND message to the vrMgr for forwarding.

The Client vrMgr, upon receiving a REGISTER_TASK message, sends a REGISTER_TASK message to the vrMGR. The Client vrMgr then determines if the corresponding task name is on the “pending resolve” list.

If a vTask in a first vrClient has data to send to a remote vTask in another vrClient, the first vrClient determines if the remote vTask can be reached. The first vrClient performs such a determination by checking the local cache of vTasks at remote vrClients, called target vrMgrEndPoints. If the local cache does not have the remote task (there is a cache miss), then the first vrClient sends the vrMgr a RESOLVE message before any SEND messages are sent. The local cache of target VrMgrEndPoint_t is searched by the first vrClient.

vTasks On vrClients Sending Data to Remote vTasks

A given vTask obtains data space by allocating space for messages, populating the data space with a message, and sending the message to the vrMgr. The vrMgr relays the information to the target vrClient. After the message is sent, the data space is freed up.

There are two types of errors:
1) A write error on connection socket:
   A write error at the vrClient results in a entire cache purge, closure of the connection socket with the vrMgr followed by a retry for re-establishment of a connection with vrMgr.
   A write error by the vrMgr on the socket to the destination vrClient results in a closure of that socket and a DEREGISTER message to all the other active vrClients.
2) Incorrect vrMgrEndPoint name: the target VrMgrEndPoint_t is checked at both originating vrClient and the vrMgr.
   An incorrect vrMgrEndPoint name at the vrClient results in an error code returned to the corresponding vrClient Send API call.
   An incorrect vrMgrEndPoint name at the vrMgr results in a DEREGISTER_TASK message generated for the originating vrClient, and would result in a cache purge of that entry. Subsequent vrClient Send calls to the same destination would result in error codes being returned to the invoking task.
      Terminating the VrClient

If the vrClient gracefully terminates, the vrClient will send a DEREGISTER message to signal the end of the connection. The vrMGr may force the vrClient to terminate with a “KILL_CLIENT” message.

vrEngines

The vrEngine module allows creation of multiple vrEngine environments. Each vrEngine is identified by an engine name. The vrEngine has an associated system logging, system tracking and a remote configuration interface. The vrEngine allows for a configurable vrEngine initial vrMgr. The vrEngine has the ability to start in one of two modes: vrMgr relay or Client vrMgr. The vrEngine spawns the initial vrMgr.

vEngines

The vEngine supports running vrApplications as vTasks in a virtual communication environment. To support such vrApplications, vTasks use a co-operative multi-tasking environment that has the following features:
can be associated with physical or logical interfaces on a box,
receive communication data streams interfaces,
link to remote configuration (AMI Configuration),
allow logging and debugging to be associated with a corresponding task,
can schedule associated sub-tasks based on timer events or message processing functions, and
support remote configuration management.

According to certain embodiments, the AMI interface can be used for remote configuration management (see associated patent application on remote construction methodology for Network Management of Communication Devices for configuration and Process Critical Network Monitoring).

The vEngines support code that create vrClients, Client VrMgrs, and vrMgrs. vTasks can be associated with vrClients and vrMgrs. If a vTask is associated with a vrClient, then the vrClient contains a link back to a vrMgr. If the vrMgr is a Client vrMgr, then Client vrMgr has a link to a vrMgr. The original vrMgr will have a link to the vrEngine. The vEngines support code that for linking vrClients to vrMgrs, Client vrMgrs to vrMgrs over the vrIPC protocol. The vEngine can search for a particular vEngine on behalf a vTask using the vri_agt_hunt( ) routine. The vrIPC protocol is started using the vr_agt_init( ) routine.

For a VR-router vrApplication, the vTasks support packet forward via a Virtual Router Forwarding Table and a Virtual Routing table that is unique to the virtual router.

The vEngines support canonical modules for creating, deleting, and locating vTasks within the vrEngine environment. Such canonical modules include:
insert_vri_peer(task *tp, const char *process_name, const char *tsk_name),
delete_vri_peer(task *tp, const char *process_name, const char *tsk_name),
find_vri_peer_by_name(task *tp, const char *process_name, const char *tsk_name), and
vri_ag_service_peer(task *tp,vri_peer entry_t*peer).

Once the vTasks locate their remote peer vTask, the vEngines support canonical code that utilize the vrIPC protocol to send information to remote vTasks. Modules for sending information to remote vTasks include:
send_vri_peer_msg(task *tp, vri_peer_entry_t *peer, const char *buf, int len),
vri_agt_send_peer_msg(task *tp, int pid, int tid, const char *buf, int len),
vri_agt_send_peer_msg_by_name(task *tp, const char *process_name, and
const char *tsk_name, const char *buf, int len).
   vrMgr Modules

Upon start-up, the vrMgr allocates a data structure per vrMgr (vrmgr_node) and allocates memory to support data structures related to clients. The vrMgr opens a well known listener using the IPC protocol; and waits for connect requests from vrClients.

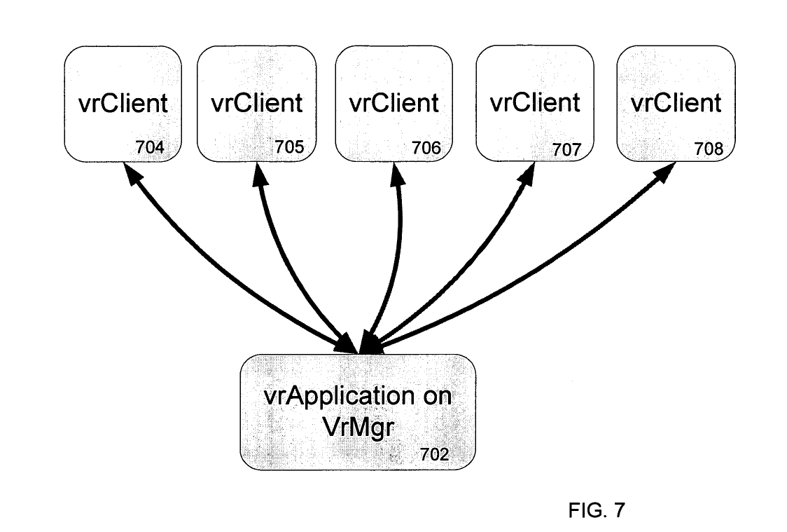

The vrApplication that is associated with the vrMgr controls the manner in which vrClients are spawned. FIG. 7 illustrates the relationship between vrMgr and vrClients. FIG. 7 shows a vrApplication on vrMgr 702 and spawned vrClients 704-708. The vrApplication on vrMgr can make use of either the vEngine's remote configuration interface or the application specific run-time parameters to configure the vrClient. The remote configuration allows vrMgr to store configuration information on policy templates. Policy templates can be tailored for each vrClient (end-point or Client vrMgr).

The vrMgr keeps track of configured vrClients (end-point or vrMgr), spawned clients, clients that are receiving configuration via a relay. The vrMgr spawns vrClients based on the vrApplication configuration and the run-time configuration.

As an example of a specific vrApplication configuration, the BR-virtual router is created based on the routing software; the CLI command of “context-router” that references the vrMgr and the “br-virtual-router boston” command causes the vrClient “boston” to be spawned. The br-virtual-router boston points to the vrMgr.

Inter-process communication messages flow through the vrMgr. The vrMgr is responsible for coordinating the name resolution service. The vrMgr detects the comings and goings of vrClients and notifies vrClients when a particular vrClient or a vrClient's task has gone away. Further, the vrMgr can provide a central clearinghouse (multiplex/de-multiplex) of messages destined to various vrClients. The vrMgr also possesses the complete list of the tasks registered to become recipients of messages. Because the inter-process communications flow through vrMgr, the vrMgr is the good place for tracing/debugging the flow of the inter-process messages. The vrClient that is in the same routing process as the vrMgr (in the BR) communicates with the vMgr using the inter-task communication model (gMsg).

The vrMgr uses a “server” flag to indicate if the vrMgr is a relay server for other vrClients. If the vrMgr is a Client vrMgr, then vrMgr as a Client vrMgr tracks both the up-level vrMgr (the Client vrMgr's server) and the down-level vrClients (the Client vrMgr's clients).

The vrMgr uses a res_pend_list to keep track of the tasks that have requested communication. Each task is tracked by engine name, task name, and task id, and requesting process id (for multi-process systems).

The vrMgr allows:
the vrApplication to configure the application type of the vrMgr,
the network management to turn “debugging” on to track information passed through the vrMgr for vrClients,
links to message passing mechanisms (TCP port, Unix Msg port, for example) and message queues,

The vrMgr App API tasks include:
static void vrmgr_cleanup_client_list(int idx);—clean up client list,
static void vrClient_init_msgs(task *tp);—initialize message to vrClients,
static void vrserver_init_msg(task *tp);—initialize relay messages to vrMgr,
static void vrmgr_accept(task *tp);—accept connection process for vrmgr,
static void vrmgr_shutdown(void);—shutdown vrMgr,
static void vrmgr_dump(task *tp, dump_func_t dump);—debug dump of vrMgr,
static void vrmgr_terminate(task *tp);—graceful termination of vrMgr,
static void vrmgr_cleanup(task *tp);—cleanup vrMgr data structures post restart,
static void vrmgr_recv(task *tp);—receive messages destined to vrMgr,
static void vrmgr_write(task *tp);—write information to vrMgr socket,
static void vrmgr_connect(task *tp);—connect to vrMgr message socket,
static void vrmgr_connection_error(task *tp, vrclient_t *vc), and
static void process_vrmgr_packet(task *tp, vrclient_t *recv_vc, vrMgrProtHdr_t *vrmgr_pkt).

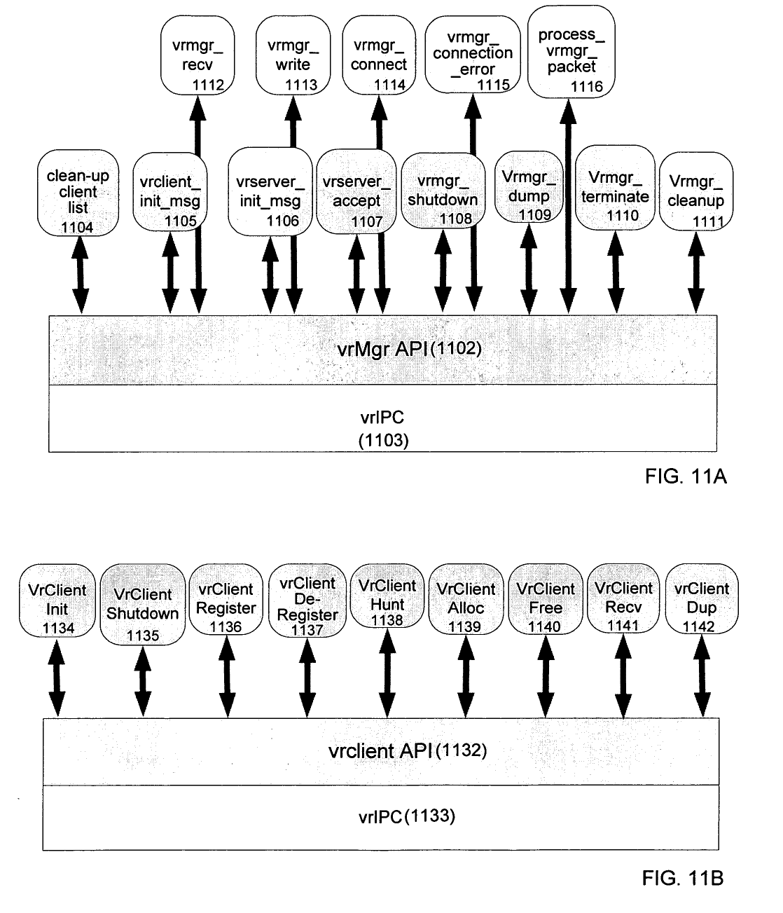

FIG. 11A illustrates the tasks associated with a vrMgr API. FIG. 11A shows vrMgr API 1102 and vrIPC 1103. FIG. 11A also shows the tasks associated with vrMgr API, such as a clean-up client task 1104, an initialize message to client task 1105, an initialize message to server (vrMgr) task 1106, an accept connection process for server (vrMgr) task 1107, a shutdown server (vrMgr) task 1108, a debug dump of server (vrMgr) task 1109, termination of server (vrMgr) task 1110, a cleanup server (vrMgr) data structures post restart task 1111, a receive messages destined to vrMgr task 1112, a write information to vrMgr socket task 1113, a connect to vrMgr message socket task 1114. a connection error to vrMgr message socket task 1115, and a processing of a vrMgr packet task 1116.

Presence Detection by vrMgr

The server vrMgr detects the closure of the communication socket of Client vrMgr and notifies the active registrants. The detection of the closure of the communication socket by a Client vrMgr results in the termination of the encasing routing client process. Such a termination uses the vrMgr exit functions below. The vrMgr detects the presence of the vrClients or Client vrMgrs by vrmgr_connect or vrmgr_accept.

vrMgr Exit Functions:
static int remove_from_spawned_list(task *tp, const char *name);
   Called by the server vrMgr upon detection of Client vrMgr disappearance. (In BR invoked by rd_notify_deregister_function);
static void notify_deregister_vr_engine(task *tp, char *vr_name);
   Called by Client vrMgr upon detection of server vrMgr disappearance.
static void notify_deregister_server(task *tp).

vrMgr Spawning and Connections:
static void vrmgr_accept(task *tp);—Accept connection process for vrmgr;
static void vrmgr_connect(task *tp);—connect to vr message socket;
static vrclient_t *create_new_remote_vrClient(task *tp, int pid, const char *vr_name, task *vc_task); and
static int spawn_vr_engine(const char *vr_name, sockaddr_un *routerid).
   vrClient Modules:

vrClient modules utilize vEngines routines. The vrClient keeps track of:
the vr_Mgr it associates to,
the vrEngine it belongs to,
the known set of vrClients,
a list of it's own vTasks that require vrIPC communication,
a remote set of vrClients with vTasks it can talk to.

Common methods in the vEngine track the number of messages and bytes the vrClient originates.

The vrClient API includes the following tasks:
1. Void VrClientInit(name)—Invoked once during the initialization sequence.
2. Void VrClientShutdown(void)—Possibly called before a graceful shutdown.
   Function: shuts down the client
   Arguments: none
   Return: Void
3. void vrClientRegister(task *tp)
   Function: A task registers with the vrClient in order to partake in the inter-process communication process.
   Arguments: The tp points to the local application task request vrIPC communication. The task name is at tp->tp_name for the application protocol.
   Return: Void
4. void vrClientDeregister(task *tp);
   Function: A task deregisters with the vrClient in order to relinquish its interest in the inter-process communication process.
   Arguments: The tp points to the local application task request vrIPC communication. The task name is at tp->tp_name for the application protocol.
   Return: Void
5. int vrClientHunt(task *tp, const char *vr_engine_name, const char *vr_task_name, vrMgrEndPoint_t *dst);
   Function: A registered task of the vrClient uses the resolved endpoint to communicate with the desired entity. If the endpoint is present in the cache it is thereby returned to the task, otherwise, a pending status is returned. When the resolution process finally completes on a successful receipt of a RESOLVE_REPLY from the vrMgr, a message is posted on tp's inter-task queue.
   Arguments: tp—task pointer for application task
      rr_engine_name—name of the vrEngine environment vr_task_name—task name dst—pointer to an end point node.
   Return code: integer indicating the status
   Note: VrClientResolve and VrClientRecv have asynchronous call semantics.
Preserving the paradigm of inter-task communication:
6. vrMgrMsg_t *vrClientAlloc(task *tp, int user_size);
   Function: meant to allocate a message block to be sent to a resolved
   Arguments: tp—application task client is associated with
      int—size of user message block
   Return code: pointer to message block structure (vrMgrMsg).
7. void vrClientFree(task *tp, vrMgrMsg_t *msg);
   Function: meant to return a message block that was allocated and used for send (vrSend) or received (vrClientRecv).
   Arguments: tp—application task client is associated with
      msg—point to message block
   Return code: none
8. int vrClientSend(task *tp, vrMgrMsg_t *msg);
   Function: send message to manger
   Arguments: tp—application task sending
      msg—vrl PC protocol messages to be sent
   Return code: returns an error if the endpoint is not found.
9. vrClientRecv(task *tp, VRMsg_t **fmsg, VRMsg_t**Imsg)
   Function: Retrieve the messages queued from the inter-task communication handler.
   Parameters: tp—pointer to application task
      VRMsg_j *fmgs—pointer to pointer to function to process message
      VRMsg_t *Imgs—pointer to pointer to message
   Return code: null
10. int vrClientMsgDup(task *tp, vrMgrMsg_t *src, vrMgrMsg_t **dst, int size);
   Function: Copy the messages queued from the inter-task communication handler.
   Parameters: tp—pointer to application task requesting copy
      VRMsg_t *src—pointer to pointer to source message
      VRMsg_t *dst—pointer to pointer to where to put copy
   Return code: status (integer).

FIG. 11B illustrates the tasks associated with a vrClient API. FIG. 11B shows vrClient API 1132 and vrIPC 1133. FIG. 11B also shows the tasks associated with vrClient API, such as a client initilization task 1134, a client shutdown task 1135, a register task 1136, a deregister task 1137, a resolve endpoint task 1138, a message allocation task 1139, a free message allocation task 1140, a retrieve message task 1141, and a copy message task 1142.

Client vrMgr Modules

The code specific to Client vrMgr modules utilizes the “relay server” function. There are routines for vrApplications Client vrMgr to obtain its server name (get_server_name( )) or the engine name (get_my_vr_engine_name( )) or particular vrClients. The search for vrClients can be by process id, name or

An application on either a client vrMgr (or a normal vrMgr) can terminate a client via the following call:
int vrmgr_terminate_client(task *tp, const char *engine_name);
   vrIPC Protocol:

Message Processing:

VrMgrEndPoint is a tuple containing: machine_id, pid, task_id.

VRMsg_t—a wrapper to the a mesage data structure used with this framework.

Protocol Message Format:

The vrIPC message format is protocol-header (dest,source, length,type) followed by type specific data. The header format is defined by:

typedef struct_vrMgrProtHdr {

vrMgrEndPoint_t ph_dest;
vrMgrEndPoint_t ph_src;
u_int32 ph_length; /* total length - including
VR_MGR_PROT_HDR_SIZE */
vrMgrCommand_t ph_command; / *enum with values below */}
vrMgrProtHdr_t;

#define VR_MGR_PROT_HDR_SIZE sizeof(vrMgrProtHdr_t)
#define VR_MGR_PROT_HDR_LENGTH_MAX 512

Table 1 describes vrIPC messages.

TABLE 1

| Message Name | Description | Msg # |
|---|---|---|
| RESOLVE_REPLY | Reply to resolve message | 0 |
| SEND | Send messages | 1 |
| RESOLVE | Resolve task address | 2 |
| REGISTER | Register vrClient with | 3 |
| | vrMgr | |
| DEREGISTER | Deregister vrClient from | 4 |
| | vrMgr | |
| REGISTER_TASK | Message generated by | 5 |
| | vrClient for each task to | |
| | register for inter-vrEngine | |
| | communication via vrIPC | |
| | protocol | |
| DEREGISTER_TASK | Message generated by a | 6 |
| | vrClient task | |
| I_AM_SERVER | Message from vrMgr or | 7 |
| | Client vrMgr indicating it is | |
| | relay server | |
| KILL_CLIENT | Message from vrMgr or | 8 |
| | Client vrMgr for vrClient | |
| | to shutdown now. | |

Format of Resolve Message

typedef struct_vr_mgr_resolve_reply {
u_int32 res_reply_pid; /* resolved pid */
u_int32 res_reply_task_id; /* resolved task id */
u_int32 res_reply_req_pid; /* requestor's pid */
u_int32 res_reply_req_task_id; /* requestor's task_id */
char res_reply_buf[1]; /* engine_name, task_name */
} vr_mgr_resolve_reply_t;

Format of REGISTER_TASK, DEREGISTER_TASK

/*
* identical header format for VR_MGR_CMD_REGISTER_TASK and
* VR_MGR_CMD_DEREGISTER_TASK. reg_tsk_num task_names
follow
* vr_mgr_reg_tsk_t for VR_MGR_CMD_REGISTER_TASK.
*/
typedef struct_vr_mgr_reg_tsk {
u_int32 reg_tsk_num; /* number of pairs reg_tsk_endpt*/
vrMgrEndPoint_t reg_tsk_endpt[1];
} vr_mgr_reg_tsk_t;

Format of REGISTER/DEREGISTER

/*
* identical formats for VR_MGR_CMD_REGISTER and
* VR_MGR_CMD_DEREGISTER commands.
*/
typedef struct_vr_mgr_reg {

u_int32 reg_pid; /* pid */
char reg_name[1]; /* vr_engine_name */

}vr_mgr_reg_t;
#endif /* PROTO_VRI */
#endif /*_VRMGR_PROT_H_*/

Table 2 describes the direction of vrIPC protocol messages.

TABLE 2
Protocol Messages Direction

| | Direction | | | |
|---|---|---|---|---|
| | VrClient to | VrMgr to | VrMgr | |
| Message Name | vrMgr | vrClient | relays | Client vrMgr relay |
| RESOLVE_REPLY | Yes | No | | |
| SEND | Yes | Yes | Yes | Yes |
| RESOLVE | | Yes | | |
| REGISTER | Yes | No | | |
| DEREGISTER | Yes | Generated upon | Yes to | Yes to other |
| | | ungraceful | other | clients |
| | | shutdown of | clients | |
| | | connection | | |
| REGISTER_TASK | Yes | No | Yes | |
| DEREGISTER_TASK | Yes | No | Yes | Yes |
| I_AM_SERVER | No | Yes; note: Client | | |
| | | vrMgr will send | | |
| KILL_CLIENT | | Yes | No | No |

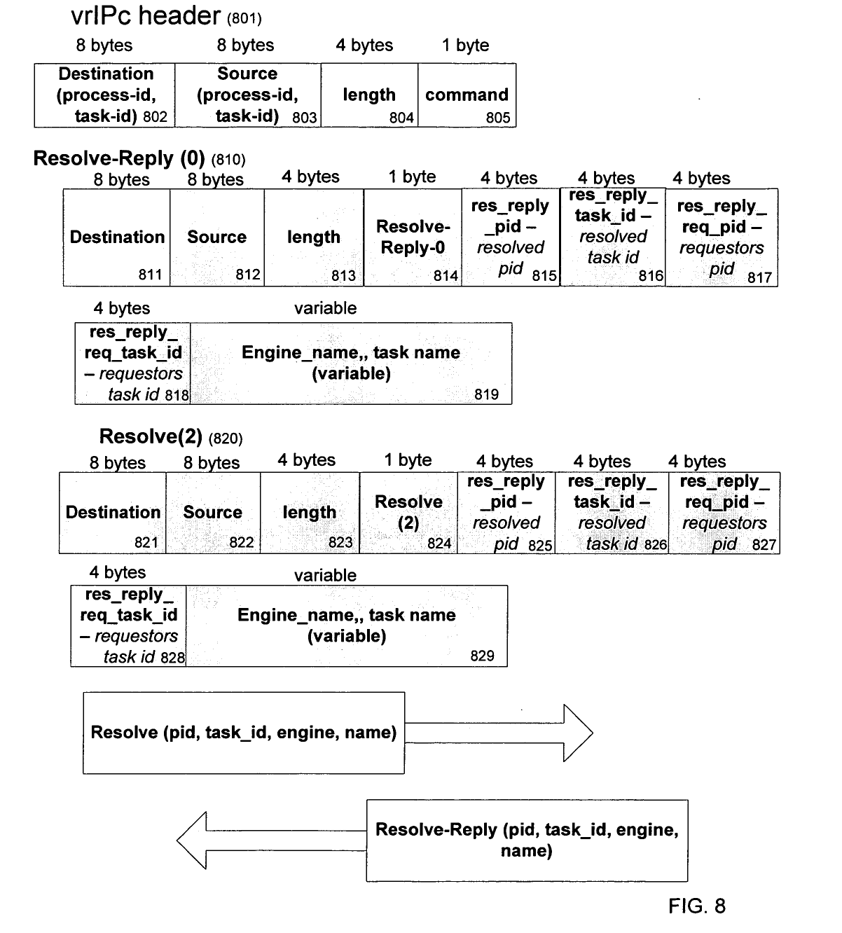

FIG. 8 illustrates the format of the Resolve, and Resolve-Reply messages, according to certain embodiments. FIG. 8 shows a vrIPC header 801, a resolve-reply message 810, and a resolve message 820. vrIPC header 801 comprises a destination field 802, a source field 803, a length field 804 and a command field 805. Resolve-reply message 810 comprises a destination field 811, a source field 812, a length field 813, a resolve-reply field 814, a resolve pid field 815, a resolve task id field 816, a requestors pid field 817, requestors task id field 818, and engine/task name field 819. Resolve message 820 comprises a destination field 821, a source field 822, a length field 823, a resolve field 824, a resolve pid field 825, a resolve task id field 826, a requestors pid field 827, requestors task id field 828, and engine/task name field 829.

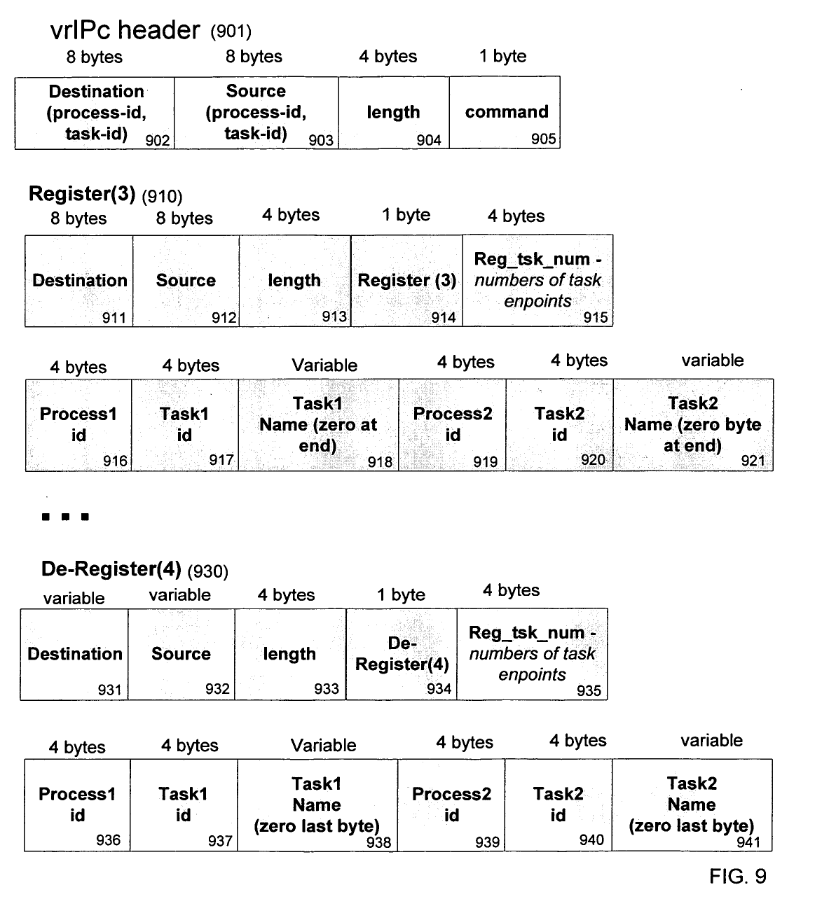

FIG. 9 illustrates the format of the Register and Deregister messages, according to certain embodiments. FIG. 9 shows a vrIPC header 901, a register message 910, and a de-register message 930. vrIPC header 901 comprises a destination field 902, a source field 903, a length field 904 and a command field 905. Register message 910 comprises a destination field 911, a source field 912, a length field 913, a register field 914, a number of task field 915, a process1 id field 916, a task1 id field 917, a task1 name field 918, a process2 id field 919, a task2 id field 920, and a task2 name field 921. De-Register message 930 comprises a destination field 931, a source field 932, a length field 933, a de-register field 934, a number of task field 935, a process1 id field 936, a task1 id field 937, a task1 name field 938, a process2 id field 939, a task2 id field 940, and a task2 name field 941.

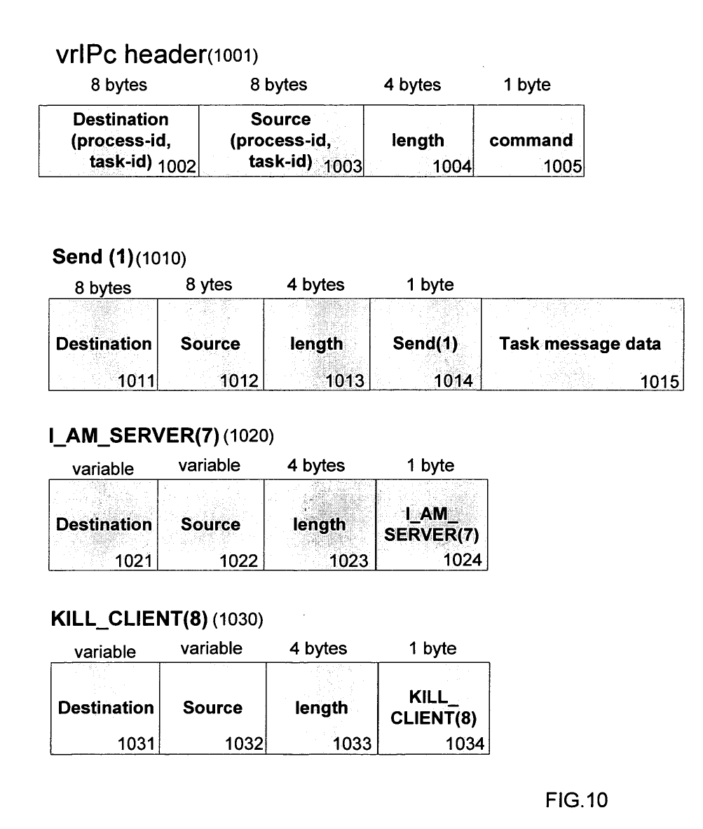

FIG. 10 illustrates the format of the Send, I-am-server, Kill-client messages, according to certain embodiments. FIG. 10 shows a vrIPC header 1001, a Send message 1010, a I_Am_Server message 1020, and a Kill_Client message 1030. vrIPC header 1001 comprises a destination field 1002, a source field 1003, a length field 1004 and a command field 1005. Send message 1010 comprises a destination field 1011, a source field 1012, a length field 1013, a task message data field 105. I_Am_Server message 1020 comprises a destination field 1021, a source field 1022, a length field 1023 and a I_am_server field 1024. Kill_Client message 1030 comprises a destination field 1031, a source field 1032, a length field 1033 and a Kill_Client field 1034.

Protocol Message Handling

1. REGISTER(vr_engine_name, pid)—This message flows from a vrClient to the vrMgr upon a successful connection establishment. This message flows from a vrClient to the vrMgr before a graceful shutdown. This message is relayed to other vrClients by the vrMgr to flush the cache of target VrMgrEndPoint_t with the pid in question. After the detection of an ungraceful termination of a vrClient by the vrMgr, it is automatically relayed to all remaining active vrClients by the vrMgr.

3. REGISTER_TASK(vr_name, task_name, pid, task_id)—Upon the initial connection establishment between a vrClient and the vrMgr, a message is generated by the vrClient for each task registered with vrClient. As new tasks are registered over time, a corresponding message is generated by the vrClient. Upon receipt of such a message by the vrMgr, RESOLVE_REPLY messages might be generated by vrMgr to other active vrClients taht have a pending matching RESOLVE request queued at the vrMgr corresponding to <vr_engine_name, vr_name, task_name>.

4. DEREGISTER_TASK(pid, task_id)—As tasks deregister with the vrClient, the DEREGISTER_TASK messages are generated by the vrClient and directed to the vrMgr. This message is also relayed back to other vrClients to flush out their cache of target VrMgrEndPoint_t associated with <pid, task_id>. The frequency of such a message is very low.

5. SEND(pid, task_id, data, . . . )—The bulk of the messages from vrClients to the vrMgr SEND messages. The SEND message is also relayed to the destined target vrClient by the vrMgr.

A write error at the vrClient results in a entire cache purge, closure of the connection socket with the vrMgr followed by a retry for re-establishment of a connection with vrMgr. A write error on the socket to the destination vrClient by the vrMgr results in a closure of that socket and a DEREGISTER message to all the other active vrClients. The target VrMgrEndPoint_t is checked at both the originating vrClient and the vrMgr. A failure at the vrClient results in a error code returned to the corresponding vrClientSend API call. A failure at the vrMgr results in a DEREGISTER_TASK message directed to the originating vrClient, which would result in a cache purge of that entry. Subsequent vrClientSend calls to the same destination would result in error codes being returned to the invoking task.

6. RESOLVE(vr_engine_name, vr_name, task_name)—This message is generated from the vrClient to the vrMgr before any SENDs are performed. The local cache of target VrMgrEndPoint_t is searched by the vrClient. This message is directed to the vrMgr in the case when there is a cache miss.

7. RESOLVE_REPLY(vr_engine_name, vr_name, task_name, pid, task_id)—This message is in response to a RESOLVE message generated by the vrClient. This message can be in response to a RESOLVE message when there is a cache hit of the target VrMgrEndPoint_t or after a receipt of a REGISTER_TASK notification from a vrClient.

A task can observe only SEND and RESOLVE_REPLY messages in its inter-task message queue to be processed (passed on by the local vrClient task within its routing pid).

In the foregoing specification, embodiments of the invention have been described with reference to numerous specific details that may vary from implementation to implementation. The specification and drawings are, accordingly, to be regarded in an illustrative rather than a restrictive sense.

1. A virtual communications network, the virtual communications network including a plurality of processors coupled via a communications channel, the virtual communications network comprising:
a plurality of virtualization engines, each of the plurality of virtualization engines comprising computer network software, wherein the plurality of virtualization engines are in communication via a inter process communication protocol, each of the plurality of virtualization engines including
one or more application modules, each of the one or more application modules implementing a network application, wherein the network application may be one of a routing protocol, a firewall, a VPN, a network management protocol,
an inter-process communications module for communication with the plurality of virtualization engines via the inter-process communication protocol,
an application programming interface for the inter-process communications modules, wherein the one or more applications modules communicate with the plurality of virtualization engines by accessing the inter-process communications module via the application programming interface;
a management software module for creating and managing the plurality of virtualization engines, wherein the management software module is operative to select, for each of the plurality of virtualization engines, a processor from the plurality of processors on which the virtualization engine operates, wherein the management software module is in communication with the plurality of virtualization engines via the inter-process communication protocol.

2. The virtual communications network of claim 1, wherein the routing protocol may include Border Gateway Protocol.

3. The virtual communications network of claim 1, wherein the routing protocol may include Open Shortest Path First.

4. The virtual communications network of claim 1, wherein the routing protocol may include Intermediate System—Intermediate System.

5. The virtual communications network of claim 1, wherein the routing protocol may include Routing Information Protocol.

6. The virtual communications network of claim 1, wherein the network application may include a storage area networking protocol.

7. The virtual communications network of claim 1, wherein the storage area networking protocol may include Fibre Channel.

8. The virtual communications network of claim 1, wherein the network management protocol may be SNMP.

9. The virtual communications network of claim 1, wherein the network management protocol may be AgentX.

10. The virtual communications network of claim 1, wherein the routing protocol includes a label-switched protocol.

11. The virtual communications network of claim 10, wherein the label-switched protocol includes a Multi Protocol Label Switching protocol.

12. The virtual communications network of claim 11, wherein the Multi Protocol Label Switching Protocol includes LDP.

13. The virtual communications network of claim 11, wherein the Multi Protocol Label Switching Protocol includes RSVP.

14. The virtual communications network of claim 1, wherein the management software module is operative to shutdown any of the plurality of virtualization engines.

15. The virtual communications network of claim 14, wherein the management software module is operative to de-allocate space previously reserved on the plurality of processors for any of the plurality of virtualization engines which have been shut down.

16. The virtual communications network of claim 1, wherein the management software module is operative to initiate additional virtualization engines.

17. The virtual communications network of claim 15, wherein the management software module is operative to allocate space on the plurality of processors for the additional virtualization engines.

18. The virtual communications network of claim 1, wherein the communications channel includes a local area network.

19. The virtual communications network, wherein the communications channel includes a wide area network.

20. The virtual communications network of claim 1, wherein the communications channel communicates at least partially via TCP/IP.

21. The virtual communications network of claim 1, wherein the management software module is operative to re-locate one or more of the plurality of virtualization engines between the plurality of processors.
